(19) United States
(12) Patent Application Publication
(10) Pub. No.: US 2024/0352169 A1
(43) Pub. Date: Oct. 24, 2024

(54) RESIN COMPOSITION, WATER-SWELLABLE FILM, ARTICLE COVERED WITH WATER-SWELLABLE FILM, AND METHOD FOR PRODUCING WATER-SWELLABLE FILM

(71) Applicant: OSAKA ORGANIC CHEMICAL INDUSTRY LTD., Osaka (JP)

(72) Inventors: Shinpei YAMAMOTO, Hakusan-shi, Ishikawa (JP); Soichi FUTAMI, Seto-shi, Aichi (JP); Yumi TAKATA, Seto-shi, Aichi (JP)

(21) Appl. No.: 18/701,293

(22) PCT Filed: Oct. 28, 2022
(86) PCT No.: PCT/JP2022/040315

§ 371 Date: Apr. 15, 2024

(30) Foreign Application Priority Data
Oct. 29, 2021 (JP) 2021-177024

(51) Int. Cl. C08F 220/36; C08F 220/28; C09D 133/14

(52) U.S. Cl. CPC C08F 220/365; C08F 220/281; C09D 133/14

(57) ABSTRACT

The present invention relates to a resin composition comprising: a polymer (I) selected from the group consisting of a polymer (a1) containing a structural unit (i) having an ester linkage type betaine structure and a polymer (b1) containing a structural unit (ii) having a betaine structure that is not of an ester linkage type and a structural unit (iii) having a carboxyl group; an organic solvent having a Hansen solubility parameter at 25° C. in which a dispersion term δD is 10 to 24 MPa^{1/2}, a polarity term δP is 5 to 19 MPa^{1/2}, and a hydrogen bonding term δH is 3 to 17 MPa^{1/2}, and having a boiling point higher than 100° C.; and water.

### TECHNICAL FIELD

The present invention relates to a resin composition, a water-swellable film, an article covered with a water-swellable film, and a method for producing a water-swellable film.

### BACKGROUND ART

Use of a polymer having a betaine structure has been studied, for example, as a coating agent in a biocompatible material. For example, Patent Document 1 describes a biocompatible polymer obtained by polymerizing a specific betaine monomer. Patent Document 2 describes a biocompatible material including a polymer obtained by polymerizing an amino acid type betaine monomer and a specific polymerizable monomer.

### PRIOR ART DOCUMENTS

### Patent Documents

Patent Document 1: JP-A-2007-130194

Patent Document 2: WO 2005/113620 A

Patent Document 3: JP-A-2010-057745

### SUMMARY OF THE INVENTION

### Problems to be Solved by the Invention

Although polymers having the structure as described above are conventionally known, none the resin compositions described in Patent Documents 1 to 3 provides a film having sufficient water swellability. Therefore, an object of the present invention is to provide a resin composition capable of forming a film superior in water swellability.

### Solutions to the Problems

In order to solve the above problem, the present inventors studied the structure of a copolymer contained in a resin composition, the composition of the resin composition, and so on. As a result, the present inventors have found that a film having superior water swellability can be obtained from a resin composition including a polymer having a specific structure, a specific organic solvent, and water, and have accomplished the present invention.

That is, the present invention includes the following preferred embodiments.
[1] A resin composition comprising:
a polymer (I) selected from the group consisting of a polymer (a1) containing a structural unit (i) having an ester linkage type betaine structure and a polymer (b1) containing a structural unit (ii) having a betaine structure that is not of an ester linkage type and a structural unit (iii) having a carboxyl group;
an organic solvent having a Hansen solubility parameter at 25° C. in which a dispersion term δD is 10 to 24 MPa^{1/2}, a polarity term δP is 5 to 19 MPa^{1/2}, and a hydrogen bonding term δH is 3 to 17 MPa^{1/2}, and having a boiling point higher than 100° C.; and
water.
[2] The resin composition according to [1], wherein
the ester linkage type betaine structure and/or the betaine structure that is not of an ester linkage type is represented by formula (1):

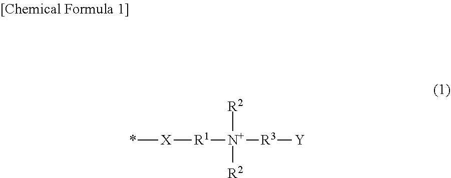

wherein:
R¹ represents a linear or branched alkylene group having 1 to 6 carbon atoms,
R² independently at each occurrence represents a linear or branched alkyl group having 1 to 4 carbon atoms,
R³ represents a linear or branched alkylene group having 1 to 4 carbon atoms,
X represents —C (═O)—O— in an ester linkage type betaine structure, and —(═O)—N(—H)— in a betaine structure that is not of an ester linkage type,
Y represents —SO₃ or —COO⁻, and
* represents a bond.
[3] The resin composition according to [1] or [2], wherein the polymer (a1) and/or the polymer (b1) further contains a structural unit having at least one hydrophilic structure.
[4] The resin composition according to any one of [1] to [3], wherein the structural units (i) to (iii) are each a structural unit derived from a (meth) acrylic monomer or a vinyl monomer.
[5] The resin composition according to any one of [1] to [4], comprisng the polymer (I) in an amount of 5% by mass to 30% by mass based on a total amount of the resin composition.
[6] The resin composition according to any one of [1] to [5], which is a coating agent.

[7] A water-swellable film comprising a polymer (II) selected from the group consisting of a polymer (a2) containing a structural unit (iv) having an ester linkage type betaine structure and a structural unit (v) having a carboxyl group, and a polymer (b1) containing a structural unit (ii) having a betaine structure that is not of an ester linkage type and a structural unit (iii) having a carboxyl group.
[8] An article covered with the water-swellable film according to [7], provided that elongated medical devices and components thereof are excluded.
[9] A method for producing the water-swellable film according to [7], the method comprising:
an application step of applying the resin composition according to any one of [1] to [6] to a substrate; and
a film formation step of heating a coating film of the applied resin composition to form a water-swellable film.

[10] The method according to [9], wherein the film formation step is a step of heating the coating film of the applied resin composition at a temperature higher than 90° C., and in the film formation step, the polymer (a1) containing the structural unit (i) having an ester linkage type betaine structure is hydrolyzed to form a polymer (a2) containing a structural unit (iv) having an ester linkage type betaine structure and a structural unit (v) having a carboxyl group.
[11] The method according to [10], wherein a hydrolysis rate from the polymer (a1) to the polymer (a2) is 5 mol % or more and 60 mol % or less.

### Effects of the Invention

In accordance with the present invention, it is possible to provide a resin composition capable of forming a film superior in water swellability.

### DETAILED DESCRIPTION

Hereinafter, embodiments of the present invention will be described in detail. The scope of the present invention is not limited to the embodiments described herein, and various modifications can be made without departing from the spirit of the present invention.

The resin composition of the present invention comprises: a polymer (I) selected from the group consisting of a polymer (a1) containing a structural unit (i) having an ester linkage type betaine structure and a polymer (b1) containing a structural unit (ii) having a betaine structure that is not of an ester linkage type and a structural unit (iii) having a carboxyl group; an organic solvent having a Hansen solubility parameter at 25° C. in which a dispersion term δD is 10 to 24 MPa^{1/2}, a polarity term δP is 5 to 19 MPa^{1/2}, and a hydrogen bonding term δH is 3 to 17 MPa^{1/2}, and having a boiling point higher than 100° C.; and water.

### Polymer (I)

The resin composition of the present invention comprises a polymer (I) selected from the group consisting of a polymer (a1) and a polymer (b1). The polymer (a1) is a polymer containing a structural unit (i) having an ester linkage type betaine structure, and the polymer (b1) is a polymer containing a structural unit (ii) having a betaine structure that is not of an ester linkage type and a structural unit (iii) having a carboxyl group. The resin composition of the present invention may contain one or two or more of the polymer (a1), or may contain one or two or more of the polymer (b1), or may contain one or two or more of the polymer (a1) and one or two or more of the polymer (b1). Thanks to comprisng the polymer (I) in the resin composition, water swellability can be imparted to a film formed from the resin composition.

The polymer (a1) is a polymer containing a structural unit (i) having an ester linkage type betaine structure. The betaine structure refers to a structure having a positive charge and a negative charge at positions not adjacent to each other in the same molecule, having no hydrogen capable of being dissociated that is bonded to an atom having a positive charge, and being electrically neutral (in other words, having no charge) as a whole. In the betaine structure, as a functional group having a positive charge, for example, any of quaternary ammonium, tertiary sulfonium, and quaternary phosphonium can be used, and as a functional group having a negative charge, for example, any of a sulfonic acid, a carboxylic acid, and a phosphonic acid can be used. That is, the betaine structure can be, for example, a sulfobetaine, a carboxybetaine, or a phosphobetaine. A structural unit in which such a betaine structure is bonded to a polymer main chain via an ester linkage is defined as a structural unit (i) having an ester linkage type betaine structure.

The polymer (b1) is a polymer containing a structural unit (ii) having a betaine structure that is not of an ester linkage type and a structural unit (iii) having a carboxyl group. The betaine structure in the structural unit (ii) also refers to a structure having a positive charge and a negative charge at positions not adjacent to each other in the same molecule, having no hydrogen capable of being dissociated that is bonded to an atom having a positive charge, and being electrically neutral (in other words, having no charge) as a whole. Examples of the betaine structure include those described for the structural unit (i). A structural unit in which such a betaine structure is bonded to a polymer main chain via a linkage other than an ester linkage, e.g., —N(—H)—, is defined as a structural unit (ii) having a betaine structure that is not of an ester linkage type.

From the viewpoint of enhancing the water swellability of a film, the betaine structure in the structural unit (i) having an ester linkage type betaine structure and the betaine structure in the structural unit (ii) having a betaine structure that is not of an ester linkage type betaine structure are each preferably a betaine structure having at least one atom selected from the group consisting of a positively charged quaternary nitrogen atom, a positively charged tertiary sulfur atom, and a positively charged quaternary phosphorus atom, and more preferably a betaine structure having a positively charged quaternary nitrogen atom.

In one preferred embodiment, the ester linkage type betaine structure and/or the betaine structure that is not of an ester linkage type is represented by formula (1):

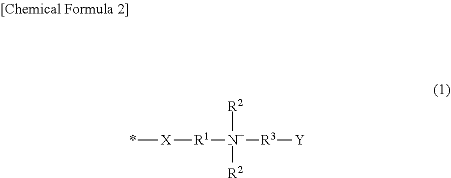

wherein:
R¹ represents a linear or branched alkylene group having 1 to 6 carbon atoms,
R² independently at each occurrence represents a linear or branched alkyl group having 1 to 4 carbon atoms,
R³ represents a linear or branched alkylene group having 1 to 4 carbon atoms,
X represents —C(═O)—O— in an ester linkage type betaine structure, and —C(═O)—N(—H)— in a betaine structure that is not of an ester linkage type,
Y represents —SO₃ or —COO⁻, and
* represents a bond.

R¹ represents a linear or branched alkylene group having 1 to 6 carbon atoms. Examples of the linear or branched alkylene group having 1 to 6 carbon atoms include a methylene group, an ethylene group, an n-propylene group, an isopropylene group, an n-butylene group, an n-pentylene group, an n-hexylene group, an isobutylene group, a methylmethylene group, a methylethylene group, a dimethylethylene group, a methylpropylene group, a methylbutylene group, and a methylpentylene group. From the viewpoint of improving the water swellability of the water-swellable film formed from the resin composition of the present invention, R¹ is preferably a linear or branched alkylene group having 1 to 4 carbon atoms, and more preferably a linear or branched alkylene group having 1 to 3 carbon atoms.

R² independently at each occurrence represents a linear or branched alkyl group having 1 to 4 carbon atoms. Examples of the linear or branched alkyl group having 1 to 4 carbon atoms include a methyl group, an ethyl group, a n-propyl group, an isopropyl group, a n-butyl group, and an isobutyl group. From the viewpoint of improving water swellability, R² is preferably an alkyl group having 1 to 3 carbon atoms, more preferably a methyl group or an ethyl group, and still more preferably a methyl group.

R³ represents a linear or branched alkylene group having 1 to 4 carbon atoms. Examples of the linear or branched alkylene group having 1 to 4 carbon atoms include a methylene group, an ethylene group, an n-propylene group, an isopropylene group, an n-butylene group, a methylmethylene group, a methylethylene group, a dimethylethylene group, and a methylpropylene group. From the viewpoint of improving water swellability, R³ is preferably an alkylene group having 1 to 3 carbon atoms, more preferably a methylene group or an ethylene group, and still more preferably a methylene group.

Y represents —SO₃⁻ or —COO⁻, and preferably represents —COO⁻.

The structural unit (iii) having a carboxyl group is not particularly limited as long as it is a structural unit having at least one carboxyl group, and may be a structural unit derived from a monomer having at least one carboxyl group. In one preferred embodiment of the present invention, the structural unit (iii) having a carboxyl group is preferably a structural unit in which a structure represented by —Z—COOH, wherein Z represents a single bond or an alkylene group having 1 to 3 carbon atoms and preferably represents a single bond, is bonded to a polymer main chain.

The polymer (a1) is a polymer containing the structural unit (i), and may have, in addition to the structural unit (i), a structural unit (ii) having a betaine structure that is not of an ester linkage type, a structural unit (iii) having a carboxyl group, a further structural unit different from the structural units (i) to (iii), for example, a structural unit (vi) having a hydrophilic structure, or the like. When a polymer has the structural unit (ii) having a betaine structure that is not of an ester linkage type and the structural unit (iii) having a carboxyl group in addition to the structural unit (i), the polymer can correspond to both the polymer (a1) and the polymer (b1).

The polymer (b1) is a polymer containing the structural unit (ii) having a betaine structure that is not of an ester linkage type and the structural unit (iii) having a carboxyl group. The polymer (b1) may also have a structural unit different from the structural unit (ii) and the structural unit (iii), for example, a structural unit (vi) having a hydrophilic structure.

The proportion of the structural unit (i) contained in the polymer (a1) is preferably 10 mol % or more, more preferably 20 mol % or more, still more preferably 30 mol % or more, and further preferably 40 mol % or more based on the amount of all structural units from the viewpoint of easily enhancing the water resistance of a film to be formed and easily enhancing the adhesion of a film to be formed to a substrate. The proportion of the structural unit (i) may be 100 mol % or less, and may be, for example, 90 mol % or less, 80 mol % or less, 70 mol % or less, 60 mol % or less, or 50 mol % or less.

When the polymer (a1) contains the structural unit (iii), the proportion of the structural unit (iii) is preferably 1 mol % or more, more preferably 3 mol % or more, and still more preferably 5 mol % or more based on the amount of all structural units from the viewpoint of lowering the formation temperature in forming a water-swellable film and from the viewpoint of enhancing the solubility in water of the polymer (a1), the water resistance of a film to be formed, and the adhesion of a film to be formed to a substrate. The proportion of the structural unit (iii) may be, for example, 30 mol % or less, 20 mol % or less, 15 mol % or less, or 10 mol % or less.

The proportion of the structural unit (ii) contained in the polymer (b1) is preferably 20 mol % or more, more preferably 30 mol % or more, and still more preferably 40 mol % or more based on the amount of all structural units from the viewpoint of easily enhancing the water resistance of a film to be formed. The proportion of the structural unit (ii) may be, for example, 70 mol % or less, 60 mol % or less, 50 mol % or less, or 45 mol % or less.

The proportion of the structural unit (iii) contained in the polymer (b1) is preferably 1 mol % or more, more preferably 3 mol % or more, and still more preferably 5 mol % or more based on the amount of all structural units from the viewpoint of enhancing the adhesion of a film to be formed to a substrate. The proportion of the structural unit (ii) may be, for example, 30 mol % or less, 20 mol % or less, 15 mol % or less, or 10 mol % or less.

The polymer (a1) and/or the polymer (b1) comprised in the resin composition of the present invention preferably further containes a structural unit (vi) having at least one hydrophilic structure from the viewpoint of improving the hydrophilicity and water swellability of a film to be formed. Examples of the hydrophilic structure in the structural unit (vi) having a hydrophilic structure include at least one structure selected from the group consisting of an amide structure, an alkylene oxide structure, and a lactam structure.

The amide structure refers to a structure having —C(═O)—NH—, and typical examples thereof include a (meth)acrylamide structure having a (meth)acrylic group. Examples of a monomer having the (meth)acrylamide structure include (meth)acrylamide, N,N-dimethyl(meth)acrylamide, N-(meth)acrylmorpholide, N-methoxymethyl(meth)acrylamide, N-hydroxymethyl(meth)acrylamide, N-hydroxyethyl(meth)acrylamide, N,N-diethyl(meth)acrylamide, N-monomethyl(meth)acrylamide, and N-monoethyl(meth)acrylamide.

The alkylene oxide structure refers to a structure in which part of the carbon forming an alkyl chain is replaced by oxygen. Examples of such a structural unit (vi) preferably include a structural unit in which a structure represented by -A-COOR⁴, wherein A represents a single bond or an alkylene group having 1 to 3 carbon atoms, preferably a single bond, and R₄ represents an alkyl group having 1 to 4 carbon atoms in which a hydroxy group is bonded to at least one carbon atom, is bonded to a polymer main chain. Examples of a monomer having the alkylene oxide structure include ethylene glycol, methoxyethylene glycol, ethoxyethylene glycol, 2-propylene glycol, 2-methoxypropylene glycol, 2-ethoxypropylene glycol, 3-propylene glycol, 3-methoxypropylene glycol, 3-ethoxypropylene glycol, 2-butylene glycol, 3-butylene glycol, 4-butylene glycol, polyethylene glycol, methoxypolyethylene glycol, polypropylene glycol, methoxypolypropylene glycol, and polybutylene glycol. Other examples of the monomer having the alkylene oxide structure include monomers having a (meth)acrylic group, and examples thereof include 2-hydroxyethyl (meth) acrylate, 2-hydroxypropyl (meth)acrylate, 3-hydroxypropyl (meth)acrylate, 4-hydroxybutyl (meth)acrylate, 3-hydroxybutyl (meth)acrylate, 2-methoxyethyl (meth)acrylate, 2-ethoxyethyl (meth)acrylate, polyethylene glycol (meth)acrylate, methoxypolyethylene glycol (meth)acrylate, ethoxypolyethylene glycol (meth)acrylate, polyethylene glycol di(meth)acrylate, and 2-hydroxyethyl vinyl ether.

The lactam structure is a structure in which a carboxyl group and an amino group form a ring through dehydration condensation, and examples thereof include a-lactam (three-membered ring), β-lactam (four-membered ring), γ-lactam (five-membered ring), and δ-lactam (six-membered ring). Examples of a monomer having the lactam structure include N-vinyl-2-caprolactam, N-vinylpyrrolidone, and N-vinylpiperidone.

When the polymer (a1) and/or the polymer (b1) further contains the structural unit (vi) having a hydrophilic structure, the proportion of the structural unit (vi) is preferably 20 mol % or more, more preferably 30 mol % or more, and still more preferably 40 mol % or more based on all structural units of the polymer (al) and/or the polymer (b1) from the viewpoint of improving the hydrophilicity and water swellability of a film to be formed. In addition, when the polymer (a1) and/or the polymer (b1) further containes the structural unit (vi) having a hydrophilic structure, the proportion of the structural unit (vi) is preferably 60 mol % or less, more preferably 55 mol % or less, and still more preferably 50 mol % or less based on all structural units of the polymer (a1) and/or the polymer (b1) from the viewpoint of improving the water resistance of a film to be formed and the adhesion of a film to be formed to a substrate.

The structural units (i) to (iii), and the structural unit (vi) and other structural units optionally contained are derived from monomers having polymerizable groups copolymerizable with each other. Examples of such monomers include (meth)acrylic monomers or vinyl monomers. The structural units are preferably structural units each derived from a (meth)acrylic monomer or a vinyl monomer from the viewpoint of ease of the production of a copolymer. The polymer (a1) may be either a homopolymer or a copolymer as long as it has the structural units described above, and when the polymer (a1) is a copolymer, it may be either a random copolymer or a block copolymer, but is preferably a random copolymer. The polymer (b1) may be either a random copolymer or a block copolymer as long as it has the structural units described above, but is preferably a random copolymer.

When the structural units (i) to (iii) are derived from (meth) acrylic monomers, the structural units (i) and (ii) may be structural units derived from monomers represented by, for example, the following formula (6):

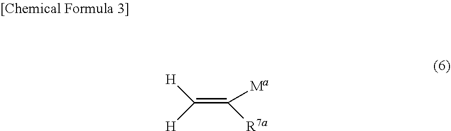

wherein:
R^{7a} is a hydrogen atom or a methyl group,
M⁸ represents an ester linkage type betaine structure for the structural unit (i) and a betaine structure that is not of an ester linkage type for the structural unit (ii), and preferably represents the above formula (1).

As such a monomer, for the structural unit (i), for example, N-methacryloyloxyethyl-N,N-dimethylammonium-α-N-methylcarboxybetaine (GLBT), 3-{[2-(methacryloyloxy)ethyl]dimethylammonio}propionate (CEBMA), and 3-{[2-(methacryloyloxy)ethyl]dimethylammonio}propane-1-sulfonate (SPBMA) can be used, and N-methacryloyloxyethyl-N,N-dimethylammonium-α-N-methylcarboxybetaine (GLBT) is preferable.

As the structural unit (ii), for example, 2-{dimethyl [3-(2-methylprop-2-enamido)-propyl]ammonio}acetate (MAMCMB), 3-[(3-methacryloylamino-propyl)-dimethyl-ammonio]-propionate (MAMCEB), 3-[(3-acryloylamino-propyl)-dimethyl-ammonio]propane-1-sulfonate (SPBAM), and 3-[(3-methacryloylamino-propyl)-dimethyl-ammonio]propane-1-sulfonate (SPBMAM) can be used, and 2-{dimethyl [3-(2-methylprop-2-enamido)-propyl]ammonio}acetate (MAMCMB) is preferable.

The structural unit (iii) may be, for example, a structural unit derived from (meth)acrylic acid.

When the structural units (i) to (iii) are derived from vinyl monomers, the structural units (i) and (ii) may be structural units derived from monomers represented by, for example, the following formula (8):

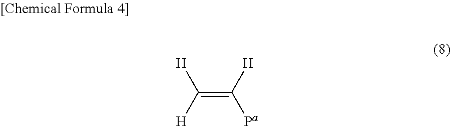

wherein P^{a} represents an ester linkage type betaine structure bonded via a divalent linking group for the structural unit (i), and a betaine structure that is not of an ester linkage type bonded via a divalent linking group for the structural unit (ii), and preferably represents a structure of the above formula (1) bonded via a divalent linking group (for example, an alkylene group having 1 to 3 carbon atoms.

The structural unit (iii) may be, for example, a structural unit derived from a monomer represented by the following formula (9):

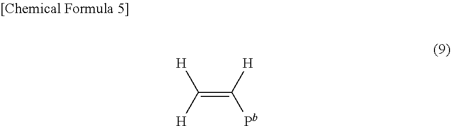

wherein P^{b} represents —Z_{b}—COOH, and Z_{b} represents an alkylene group having 1 to 3 carbon atoms.

A preferred embodiment of the present invention in which the structural units (i) to (iii) are structures derived from (meth)acrylic monomers will be described. In the present embodiment, the polymer (a1) containing the structural unit (i) may be a polymer containing at least a structural unit represented by the following formula (10).

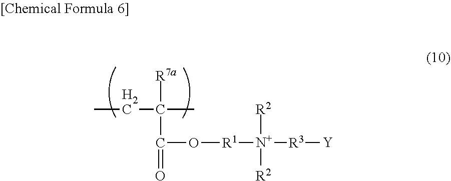

In addition, the polymer (b1) containing the structural units (ii) and (iii) may be a polymer containing at least a structural unit represented by the following formula (11).

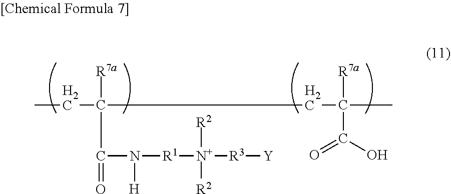

The polymers (a1) and (b1) may further have a structural unit (vi) represented by the following formula (12).

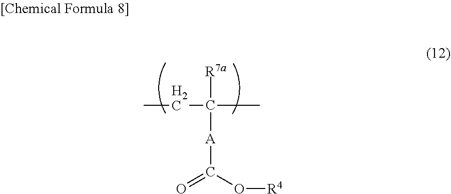

R¹, R², R³, and Y in the formulas (10) to (12) are as defined for R¹, R², R³, and Y in the formula (1). R⁴ represents an alkyl group having 1 to 4 carbon atoms in which a hydroxy group is bonded to at least one carbon atom. R^{7a} represents a hydrogen atom or a methyl group. A represents a single bond or an alkylene group having 1 to 3 carbon atoms, and preferably represents a single bond.

The weight-average molecular weight of the polymer (I) contained in the resin composition of the present invention is preferably 100 or more, more preferably 500 or more, still more preferably 1,000 or more, further preferably 10,000 or more, and particularly preferably 50,000 or more from the viewpoint of enhancing the water swellability and the water resistance of a water-swellable film obtained from the resin composition, and is preferably 1,000,000 or less, more preferably 500,000 or less, still more preferably 200,000 or less, and further preferably 150,000 or less from the viewpoint of solubility in a solvent or the like and ease of coating when used as a coating material. The weight-average molecular weight of the polymer (I) can be determined by gel permeation chromatography (hereinafter referred to as GPC). The weight-average molecular weight by GPC may be measured using, for example, trifluoroethanol as an eluent and using a column (for example, Wako Beads G-50 manufactured by FUJIFILM Wako Pure Chemical Corporation). As a molecular weight standard, polyethylene glycol may be used.

The viscosity-average molecular weight of the polymer (I) contained in the resin composition of the present invention is preferably 100 or more, more preferably 500 or more, still more preferably 1,000 or more, further preferably 10,000 or more, and particularly preferably 50,000 or more from the viewpoint of easily enhancing the water swellability and the water resistance of a water-swellable film obtained from the resin composition, and is preferably 1,000,000 or less, more preferably 500,000 or less, still more preferably 200,000 or less, and further preferably 150,000 or less from the viewpoint of solubility in a solvent or the like and ease of coating when used as a coating material. The viscosity-average molecular weight of the polymer (I) may be measured using, for example, the method described in Examples.

The method for producing the polymer (a1) is not particularly limited, but the polymer (a1) can be produced by polymerizing a monomer having a polymerizable group and the structural unit (i) together, in some cases, with a monomer having the structural unit (ii) having a polymerizable group copolymerizable with each other, the structural unit (iii), the structural unit (vi) and/or another structural unit.

The method for producing the polymer (b1) is also not particularly limited, and the polymer (b1) can be produced by copolymerizing a monomer having a polymerizable group and the structural unit (ii) and a monomer having a polymerizable group copolymerizable with that monomer and the structural unit (iii) together, in some cases, with a monomer having a polymerizable group copolymerizable with each other and the structural unit (vi) and/or another structural unit.

When the polymer (I) is produced, it is preferable to use at least one polymerization initiator from the viewpoint of promoting the polymerization reaction of the monomer components. Examples of the polymerization initiator include azo-based lipid-soluble polymerization initiators such as azoisobutyronitrile, methyl azoisobutyrate, and azobisdimethylvaleronitrile; azo-based water-soluble polymerization initiators such as 2,2′-azobis[2-(2-imidazolin-2-yl) propane], 2,2′-azobis [2-(2-imidazolin-2-yl) propane] dihydrochloride, and 2,2′-azobis [2-methyl-N-(2-hydroxyethyl)propionamide]; inorganic peroxides such as benzoyl peroxide, potassium persulfate, and ammonium persulfate; and photopolymerization initiators such as benzophenone derivatives, phosphine oxide derivatives, benzoketone derivatives, phenylthioether derivatives, azide derivatives, diazo derivatives, and disulfide derivatives, but the present invention is not limited only to these examples. Such polymerization initiators may be used singly, or two or more of them may be used in combination. The amount of the polymerization initiator is not particularly limited, but is usually preferably about 0.01 to 5 parts by mass per 100 parts by mass of the monomer components.

Examples of the polymerization method for producing the polymer (I) include a bulk polymerization method, a solution polymerization method, an emulsion polymerization method, and a suspension polymerization method, but the present invention is not limited to these examples. Among these polymerization methods, a solution polymerization method is preferable. In the case of polymerizing monomer components by a solution polymerization method, for example, the monomer components can be polymerized by dissolving the monomer components in a solvent and adding a polymerization initiator while stirring the solution obtained. Although the polymerization method for producing the copolymer may be either photopolymerization or thermal polymerization, thermal polymerization is preferable from the viewpoint of manufacturability.

Examples of the solvent to be used for the production of the polymer (I) include water; alcohols such as methyl alcohol, ethyl alcohol, isopropyl alcohol, ethylene glycol, and propylene glycol; ketones such as acetone and methyl ethyl ketone; ethers such as diethyl ether and tetrahydrofuran; aromatic hydrocarbon compounds such as benzene, toluene, and xylene; aliphatic hydrocarbon compounds such as n-hexane; alicyclic hydrocarbon compounds such as cyclohexane; acetic acid esters such as methyl acetate and ethyl acetate; and aprotic polar solvents such as dimethylformamide (hereinafter, referred to as DMF) and dimethyl sulfoxide (hereinafter, referred to as DMSO), but the present invention is not limited only to these examples. These solvents may be used singly or two or more of them may be used in combination.

In usual, the amount of the solvent in the production of the polymer (I) is preferably adjusted such that the concentration of the monomer components in a solution obtained by dissolving the monomer components in the solvent is about 10 to 80% by mass.

Polymerization conditions set when the monomer components are polymerized, such as the polymerization temperature and the polymerization time, are preferably appropriately adjusted according to the type and use amount of the monomers to be used as the monomer components, the type and use amount of the polymerization initiator, and so on.

The atmosphere for polymerizing the monomer components is preferably an inert gas. Examples of the inert gas include nitrogen gas and argon gas, but the present invention is not limited to these examples.

### Organic Solvent

The resin composition of the present invention contains at least one organic solvent having a Hansen solubility parameter at 25° C. in which a dispersion term δD is 10 to 24 MPa^{1/2}, a polarity term δP is 5 to 19 MPa^{1/2}, and a hydrogen bonding term δH is 3 to 17 MPa^{1/2}, and having a boiling point higher than 100° C. The resin composition of the present invention may contain one organic solvent having the specific Hansen solubility parameter and the specific boiling point, or may contain two or more organic solvents each having the specific Hansen solubility parameter and the specific boiling point, or may contain other organic solvents in addition to these organic solvents.

When the resin composition of the present invention contains the specific organic solvent described above, the water swellability of a water-swellable film formed from the resin composition of the present invention is improved. The reason why it is possible to improve the water swellability of the film when the specific organic solvent is contained is not clear, but it is considered to be due to, for example, the following mechanism. The specific organic solvent is considered to be a solvent having moderate incompatibility with the polymer (I) and moderate miscibility with water. When the resin composition contains such an organic solvent, water evaporates preferentially over the organic solvent in obtaining a coating film by applying the resin composition to a substrate and drying and removing the organic solvent and water. Therefore, as the drying progresses, the proportion (concentration) of the organic solvent in the coating material relatively increases, and the polymer (I) dissolved in water is easily precipitated and aggregated as compared with a case where a resin composition does not contain the organic solvent. It is considered that, as a result, generation of electrostatic interaction due to a betaine structure and a carboxylic acid structure described later and formation of an ampholyte structure are promoted in the polymer (I), so that a crosslinked structure capable of retaining water in the structure is easily formed, and a gel exhibiting water resistance and swelling characteristics is easily obtained. It is noted that the present invention is not limited to this mechanism at all.

In the Hansen solubility parameter of the organic solvent at 25° C., the fact that the dispersion term δD is 10 to 24 MPa^{1/2}, the polarity term δP is 5 to 19 MPa^{1/2}, and the hydrogen bonding term δD is 3 to 17 MPa^{1/2} indicates that the solvent has specific solubility characteristics. Specifically, the organic solvent having the solubility parameter as described above is considered to be a solvent having moderate incompatibility with the polymer (I) and moderate miscibility with water. For example, when the hydrogen bonding term δH of the Hansen solubility parameter exceeds 17 MPa^{1/2}, the solvent has low incompatibility with the polymer (I) and is soluble in some cases, so that a gel structure formed from the polymer (I) is hardly generated. As a result, it becomes difficult to enhance the water resistance and swellability of a resulting film. When the polymer (I) is a polymer (a1) containing a structural unit (i) having an ester linkage type betaine structure, hydrolysis of the polymer (al) described later hardly occurs, and as a result, a gel structure hardly occurs. When the hydrogen bonding term SH is less than 3 and when the polarity term δP is less than 5, moderate miscibility with water is not exhibited, and separation occurs in some cases, so that a gel structure formed from the polymer (I) is hardly generated.

The dispersion term 8D is 10 to 24 MPa^{1/2}, preferably 12 to 20 MPa^{1/2}, and more preferably 15 to 19 MPa^{1/2}.

The polarity term δP is 5 to 19 MPa^{1/2}, preferably 8 to 17 MPa^{1/2}, and more preferably 10 to 15 MPa^{1/2}.

The hydrogen bonding term δH is 3 to 17 MPa^{1/2}, preferably 5 to 14 MPa^{1/2}, and more preferably 7 to 13 MPa^{1/2}.

As the Hansen solubility parameter of the organic solvent contained in the resin composition of the present invention, a value recorded in calculation software Hansen Solubility Parameter in Practice (H SPiP, manufacturer: Charles M. Hansen) may be used. When the resin composition of the present invention contains one organic solvent, the Hansen solubility parameter of the organic solvent is just required to be within the above range. When two or more organic solvents are contained, it is just required that at least one of the organic solvents satisfies the Hansen solubility parameter described above.

It is preferred for the Hansen solubility parameter of the organic solvent contained in the resin composition of the present invention that the dispersion term δD, the polarity term δP, and the hydrogen bonding term δH satisfy the following relationship:
√((δD−17)²+(δP−12)²+(δH−10²)²)≤7. The value calculated by the formula is preferably 7 or less. The above formula represents that the organic solvent belongs to a Hansen sphere having an interaction radius R=7 with respect to the center value having a dispersion term δD=17, a polarity term δP=12, and a hydrogen bonding term δH=10.

The organic solvent contained in the resin composition of the present invention has a boiling point higher than 100° C. The boiling point of the organic solvent is a temperature higher than 100° C., and is preferably 101° C. or higher, more preferably 110° C. or higher, still more preferably 115° C. or higher, further preferably 120° C. or higher, particularly preferably 150° C. or higher, and especially preferably 180° C. or higher from the viewpoint of enhancing the water swellability of a film to be formed. In addition, the boiling point of the organic solvent contained in the resin composition of the present invention is preferably 205° C. or lower from the viewpoint of manufacturability and availability of a water-swellable film to be obtained. When the resin composition of the present invention contains a plurality of organic solvents, it is just required that at least one organic solvent is an organic solvent having the boiling point described above.

### Water

The resin composition of the present invention contains at least water. Since the polymer (I) is usually a hydrophilic polymer and is soluble in water, it is considered that when the resin composition of the present invention contains water as a solvent, the polymer in the resin composition of the present invention can be stably contained.

The content of the polymer (I) contained in the resin composition of the present invention is not particularly limited, but is preferably 1 to 90% by mass, more preferably 5 to 50% by mass, and still more preferably 8 to 20% by mass based on the total amount of the resin composition of the present invention from the viewpoint of easily imparting high hydrophilicity and high water resistance to a water-swellable film or the like to be obtained from the resin composition. The resin composition of the present invention may contain either one type of the polymer (I) or two or more types of the polymer (I).

The content of the organic solvent having the specific Hansen solubility parameter and boiling point contained in the resin composition of the present invention is not particularly limited, but is preferably 1 to 90% by mass, more preferably 2 to 70% by mass, still more preferably 3 to 50% by mass, further preferably 4 to 30% by mass, and particularly preferably 5 to 20% by mass based on the total amount of the resin composition of the present invention from the viewpoint of imparting water resistance to a film, a hydrogel or the like to be obtained from the resin composition.

The content of the water contained in the resin composition of the present invention is not particularly limited, but is preferably 1 to 90% by mass, more preferably 10 to 95% by mass, still more preferably 20 to 90% by mass, further preferably 40 to 85% by mass, and particularly preferably 50 to 80% by mass based on the total amount of the resin composition of the present invention.

### Other Components

The resin composition of the present invention may include a component other than the polymer (I), the specific organic solvent, and the water. The other component may be appropriately chosen according to the application of the resin composition of the present invention, and examples thereof include fillers such as inorganic particles and organic particles, pigments, dyes, thickeners, surface tension agents, wettability modifiers, thixotropy modifiers, surfactants, defoamers, antioxidants, and ultraviolet absorbers. The amount of the other component also may be appropriately adjusted according to the application of the resin composition of the present invention and the function of the other component, and may be, for example, 0.01 to 99.99% by mass based on the weight of the resin composition of the present invention.

### Resin Composition

The resin composition of the present invention containing the components described above can be used as a water-swellable film-forming agent, a coating agent, and the like. The resin composition of the present invention is preferably a coating agent. By applying the resin composition of the present invention to a substrate and then heating the resin composition, a water-swellable film can be formed on the substrate. Here, by the heating, a film that is derived from the polymer (a1) and/or the polymer (b1) contained in the resin composition of the present invention, is insoluble in water, and has swellable properties in water is formed.

When the resin composition of the present invention includes the polymer (al) containing the structural unit (i) having an ester linkage type betaine structure, some structural units of a plurality of structural units (i) repeatedly contained in the polymer (a1) turn to structures having a carboxyl group through hydrolysis of the ester linkage moiety of the ester linkage type betaine structure by heating to form a structure having a carboxyl group. Then, a relatively strong electrostatic interaction occurs between a betaine structure moiety of the structural unit (i) remaining without being hydrolyzed and a hydroxy group in the structure having a carboxyl group generated via the hydrolysis, whereby a crosslinked structure is generated. It is considered that this crosslinked structure can hold water in a network thereof and has so-called flexibility or stretchability, whereby a water-swellable film having high water swellability is formed. It is considered that the water-swellable film becomes a hydrogel by swelling with water. Such an electrostatic interaction is, for example, an interaction stronger than an electrostatic interaction that can occur between a betaine structure moiety and a hydroxy group moiety contained in a structural unit having another hydrophilic structure. In addition, it is considered that ampholyte formation occurs as well between a betaine structure moiety of the structural unit (i) remaining without being hydrolyzed and a carboxyl group generated via the hydrolysis, and a crosslinked structure derived from the conversion into an ampholyte is also formed.

This will be further described by taking, as an example, a polymer (a1′) having a structural unit derived from N-methacryloyloxyethyl-N,N-dimethylammonium-α-N-methylcarboxybetaine (also referred to as “GLBT”) as the structural unit (i) and a structural unit derived from hydroxypropyl methacrylate (also referred to as “HPMA”) as the structural unit (vi).

The polymer (a1′) obtained by copolymerizing GLBT and HPMA has a positively charged moiety in a betaine structure and an —OH group in a hydrophilic structure, but the electrostatic interaction generated therebetween is weak. Therefore, when a film is formed from a resin composition containing such a polymer, a film having water swellability cannot be obtained.

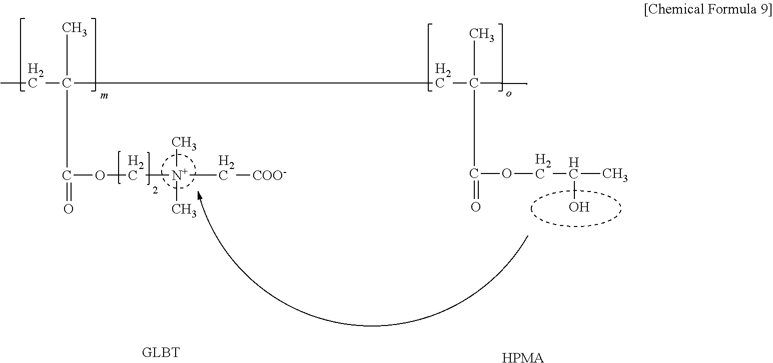

When such a polymer (a1′) is heated at above a certain temperature (for example, a temperature higher than 100° C.) in the presence of the specific organic solvent and water contained in the resin composition of the present invention, a part of the structural unit derived from GLBT is hydrolyzed to form a structure having a carboxyl group as shown in the following formula.

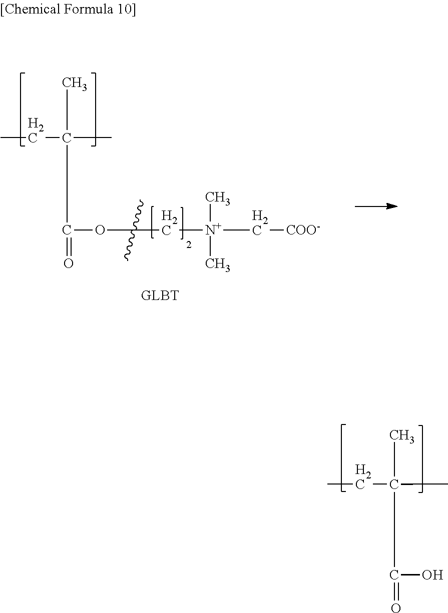

As a result, a polymer (a2′) having a structural unit shown below is generated. The polymer (a2′) is a polymer in which a p mol % portion of m mol % of structural units derived from GLBT contained in the polymer (a1′) is hydrolyzed, and is a polymer having (m-p) mol % of structural units derived from GLBT, p mol % of structural units having a carboxyl group formed via hydrolysis of GLBT, and o mol % of structural unit derived from HPMA. It is considered that the electrostatic interaction between the positively charged moiety in the betaine structure in the polymer (a2′) and the —OH group of the structural unit having a carboxyl group is very strong, and this electrostatic interaction forms a relatively strong crosslinked structure to afford a film having water swellability. Although an interaction in a polymer is shown in the following scheme, it is considered that the same interaction occurs also between adjacent polymer chains.

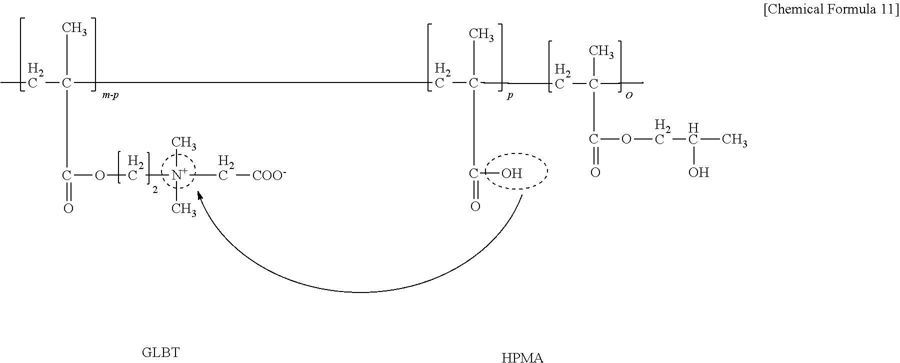

In addition, it is also considered that at least a part of the betaine structure moiety and the carboxyl group moiety is converted into an ampholyte via, for example, a reaction as shown in the following scheme.

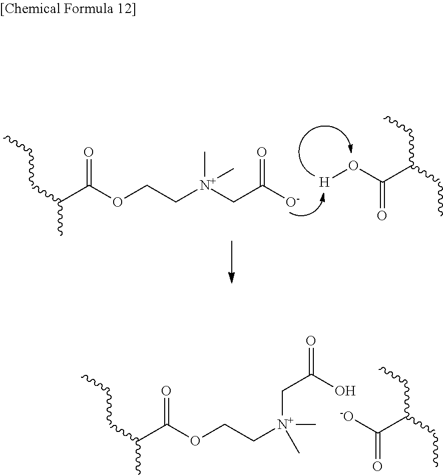

Therefore, it is considered that by heating the polymer (a1) containing the structural unit (i) having an ester linkage type betaine structure in the presence of water and the specific organic solvent contained in the resin composition of the present invention at a temperature at which the ester linkage moiety is hydrolyzed, for example, a temperature higher than 100° C., the interaction described below occurs, a crosslinked structure derived from an ampholyte is also formed, and a water-swellable film is formed.

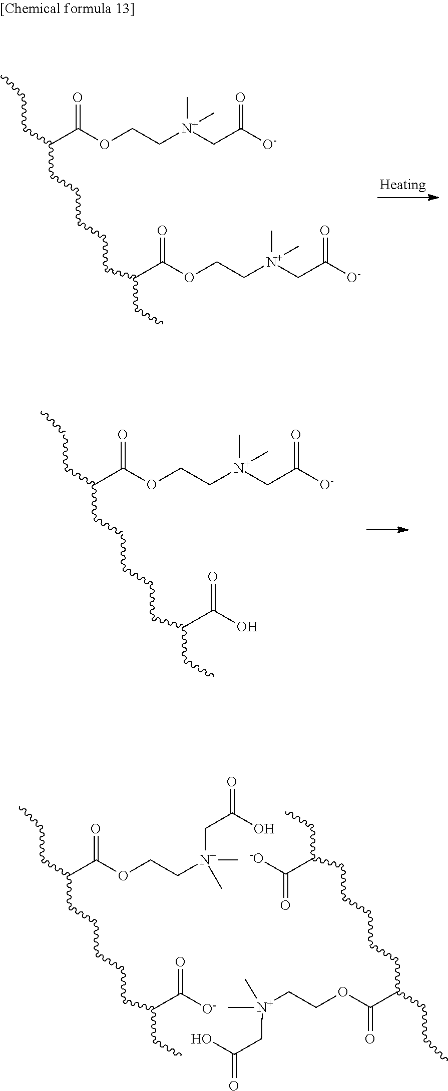

When the resin composition of the present invention includes the polymer (b1) containing the structural unit (ii) having a betaine structure that is not of an ester linkage type and the structural unit (iii) having a carboxyl group, the structural unit (ii) having a betaine structure that is not of an ester linkage type is not a structure that is hydrolyzed under heating conditions like those described above, and therefore the structural unit (iii) having a carboxyl group needs to be introduced into the polymer (b1) in advance. It is considered that the electrostatic interaction between the positively charged moiety in the betaine structure that is not of an ester linkage type in the polymer (b1) and the carboxyl group moiety is very strong similarly as described above for the polymer (a2), and this electrostatic interaction results in a film having water swellability. In addition, it is considered that these polymers are also converted into an ampholyte at least in a part thereof.

### Water-Swellable Film

By covering a substrate or the like with the resin composition of the present invention and then heating and drying the resin composition, a water-swellable film having superior swellability to water can be obtained. The present invention also provides the water-swellable film. The water swellability referred to in the present invention means that a water-swellable film increases in volume through absorption of water, and it is considered that when water is retained in the crosslinked structure formed of the polymer (I) in the water-swellable film as described above, the water swellability is developed. The water swellability in the present invention not only is by swellability by water (pure water), but also is developed by an aqueous solution. The proportion of water in the aqueous solution is not particularly limited, but, for example, is preferably 90% or more, and more preferably 95% or more. Examples of such an aqueous solution include physiological saline (an aqueous solution containing at least about 0.9% by mass of sodium chloride) and a mixed solution of water and ethanol. The water-swellable film of the present invention includes not only a film in a state of being swollen by water but also a film in a state of being able to be swollen by water (so-called dry state). The water-swellable film of the present invention comprises a polymer (II) selected from the group consisting of a polymer (a2) containing a structural unit (iv) having an ester linkage type betaine structure and a structural unit (v) having a carboxyl group, and a polymer (b1) containing a structural unit (ii) having a betaine structure that is not of an ester linkage type and a structural unit (iii) having a carboxyl group.

The water-swellable film of the present invention can be produced by a production method comprising:
(1) an application step of applying the resin composition of the present invention to a substrate; and
(2) a film formation step of heating a coating film of the applied resin composition to form a water-swellable film. The present invention also provides a method for producing the water-swellable film of the present invention.

The application step (1) is a step of applying the applied resin composition to a substrate.

The film formation step (2) is a step of heating a coating film of the applied resin composition to form a water-swellable film. The temperature at which the coating film is heated is not particularly limited as long as at least a part of the organic solvent and the water contained in the resin composition can be removed.

When the polymer (I) contained in the resin composition is the polymer (al) and does not contain the structural unit (iii) having a carboxyl group, in order to hydrolyze a part of the ester linkage type betaine structure moieties of the polymer (a1) to form the structural unit (iii) having a carboxyl group, the film formation step is preferably a step of heating a coating film of the applied resin composition at a temperature higher than 90° C., and more preferably a step of heating the coating film at a temperature higher than 100° C. In order to form the structural unit (iii) having a carboxyl group and form a crosslinked structure, the film formation step preferably involves heating the applied resin composition at a temperature equal to or lower than the boiling point of the organic solvent contained in the resin composition. In this case, in the coating film formation step, the polymer (al) containing the structural unit (i) having an ester linkage type betaine structure is hydrolyzed to become a polymer (a2) containing the structural unit (iv) having an ester linkage type betaine structure and the structural unit (v) having a carboxyl group. The heating temperature and the heating time may be appropriately adjusted according to the type and the like of the polymer, but it is preferable to set such conditions that the hydrolysis rate from the polymer (a1) to the polymer (a2) is preferably 5 mol % or more and 60 mol % or less. The hydrolysis rate from the polymer (a1) to the polymer (a2) is more preferably 10 to 45 mol %, and still more preferably 13 to 40 mol %. The hydrolysis rate is calculated by the following equation.

Hydrolysis rate (%)={(Number of moles of ester linkage type betaine of polymer (a1) before hydrolysis−Number of moles of ester linkage type betaine in polymer (a2))/number of moles of ester linkage type betaine of polymer (a1) before hydrolysis}×100

The ratio of the structural unit (iv) having an ester linkage type betaine structure to the structural unit (v) having a carboxyl group contained in the polymer (a2) (structural unit (iv): structural unit (v)) is preferably 90:10 to 10:90 (molar ratio), more preferably 87:13 to 60:40, and still more preferably 80:20 to 60:40. In addition, since the polymer (a2) is a polymer in which a part of the ester linkage type betaine structures of the polymer (a1) is hydrolyzed, descriptions on a structure that is not changed by hydrolysis, and so on made above regarding the polymer (a1) similarly apply to the polymer (a2).

### Article

The present invention also provides an article covered with the water-swellable film and components thereof, provided that the article excludes elongated medical devices such as catheters and guide wires, and components thereof. The method for covering an article with the water-swellable film of the present invention is not particularly limited, and examples thereof include applying the resin composition of the present invention to a surface or the like of an article to be coated and heating the resin composition as described in the above-described method for producing the water-swellable film of the present invention. The article covered with the water-swellable film of the present invention has high water swellability and also has high water resistance. Examples of such an article include those described later.

The water-swellable film of the present invention may be used, for example, by applying to or mixing with, for example, optical members such as optical filters, spectacle lenses, in-vehicle lenses, optical lenses, prisms, and beam splitters; mirrors; optical members used for screen surfaces of displays such as liquid crystal displays, plasma displays, electroluminescent displays, and CRT displays, and projection televisions; windows, bodies, etc. of automobiles; exterior walls, window glass, etc. of buildings; fuselages, windowpanes, etc. of aircrafts; wet areas of kitchens, bathrooms, toilets, etc.; solar panels; touch panels of liquid crystal display devices, inner walls of water supply pipes; outer surfaces of inner wires constituting control cables and inner surfaces of outer casings constituting control cables; marine material surfaces such as ship bottoms and aquaculture equipment; sensors; medical devices such as artificial hearts, artificial kidneys, and artificial blood vessels (including neither elongated medical devices, such as catheters and guide wires, nor constituent members thereof; that is, the medical devices referred to in the present invention are medical devices which are neither elongated medical devices nor constituents members thereof); cosmetics to be used for skin care, makeup, hair care, hair styling, etc.; cosmetic tools and containers such as cosmetic puffs, cosmetic pens, and compacts; coloring materials such as inkjet ink, pigment ink, and dye ink; treatment agents for fibers such as paper and cloth; polymer flocculants to be used for sewage treatment; surfactants to be used for detergents, etc.; and hydrophilic primers for electroplating. In that case, high water swellability and high water resistance can be imparted to an article covered with the water-swellable film of the present invention, and as a result, functions such as biocompatibility, antifouling property, protein adhesion preventing property, cell adhesion preventing property, antifogging property, pollen adsorption preventing property, atmospheric fine particle adhesion preventing property, and virus adhesion preventing property can be imparted to the surface of the article.

The material constituting the substrate to be covered with the water-swellable film is not particularly limited, and may be, for example, a metal or a polymer material (resin).

As the metal constituting the metal substrate, for example, an element that forms a metallic bond, such as iron (Fe), chromium (Cr), nickel (Ni), molybdenum (Mo), cobalt (Co), titanium (Ti), tungsten (W), platinum (Pt), gold (Au), silver (Ag), or tin (Sn), can be used alone or in an alloy state. More specifically, a stainless alloy, a nickel-titanium alloy, a cobalt-chromium alloy, a platinum alloy, tungsten, a silver-tin alloy, and the like can be suitably used.

The water-swellable film of the present invention has high water swellability and has high water resistance. Therefore, the surface of an article covered with a gel formed of the water-swellable film swollen by water can maintain the gel film for a long period of time. Furthermore, the water-swellable film of the present invention has high lubricity after swelling in water. Such a film has very high biocompatibility, for example, in applications of medical devices such as artificial hearts, artificial kidneys, and artificial blood vessels (medical devices that are neither elongated medical devices nor constituent members thereof).

The thickness of the water-swellable film is not particularly limited, and may be appropriately set according to the application, but may be, for example, approximately 1 μm to 1000 μm. The thickness of the gelled water-swellable film after swelling the water-swellable film in water may also be about 1 μm to 1000 μm.

The gelled water-swellable film after swelling the water-swellable film in water (also referred to as swollen gel film) includes a polymer (II) swollen by water and selected from the group consisting of the polymer (a2) and the polymer (b1). The swollen gel film is a hydrogel film formed from the water-swellable film of the present invention by containing water and swelling, and the degree of swelling thereof is, for example, 180% or more and 900% or less, and preferably 300% or more and 800% or less. The degree of swelling is calculated as d2/d1×100 (%), where d1 is the thickness when the swollen gel film is sufficiently dried (for example, dried to a water content of 0.1% by weight or less), and d2 is the thickness when the swollen gel film is sufficiently swollen. In the present embodiment, the swollen gel film may be a physically crosslinked gel.

The weight swelling rate of the swollen gel film is, for example, 2 times or more and 30 times or less, and preferably 3 times or more and 20 times or less. The weight swelling rate is calculated by wb/wa, where wa is the weight when the swollen gel film is sufficiently dried (for example, dried to a water content of 0.1% by weight or less), and wb is the weight when the swollen gel film is sufficiently swollen.

### EXAMPLES

Hereinafter, the present invention is described in more detail by way of Examples, which, however, do not limit the scope of the present invention. Note that “%” and “part(s) ” in Examples represent “% by mass” and “part(s) by mass”, respectively, unless otherwise specified.

In Examples and Comparative Examples, the monomers given in Table 1 below were used.

TABLE 1

| Abbreviations | Name of compound | Structure |
|---|---|---|
| GLBT | N-Methacryloyloxyethyl-N,N- dimethylammonium-α-N- methylcarboxybetaine | 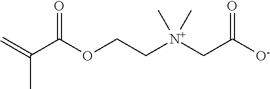 |
| MAMCMB | 2-{Dimethyl[3-(2-methylprop-2- enamido)-propyl]ammonio}acetate | 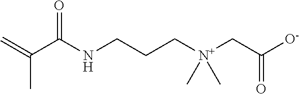 [SMILES: C=C(C)C(=O)NCCC[N+](C)(C)CC(=O)[O-]] |
| HPMA | Hydroxypropyl methacrylate (mixture of 2-hydroxypropyl ester and 2- hydroxy-1-methylethyl ester) | 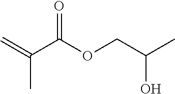 |
| HEMA | 2-Hydroxyethyl methacrylate | 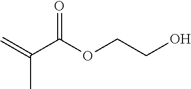 |
| MAA | Methacrylic acid | 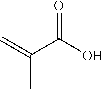 |

### Viscosity-Average Molecular Weight

Using an Ubbelohde viscometer, the viscosity of a 1% solution of a copolymer was determined at 25° C. The viscosity determined was applied to a viscosity/molecular weight curve prepared using polyvinylpyrrolidone having a known molecular weight, whereby the viscosity-average molecular weight of the copolymer was determined.

### Example 1

### Synthesis of Copolymer 1: GLBT-HEMA

GLBT (manufactured by Osaka Organic Chemical Industry Ltd.) and HEMA (manufactured by Osaka Organic Chemical Industry Ltd.) were dissolved in water in a reactor equipped with a condenser, a thermometer, a nitrogen inlet tube, and a stirrer such that the molar ratio was 50:50 and the total concentration of the monomers was 10%. Subsequently, dissolved oxygen was removed by purging with an inert gas, and then the temperature was raised to 50° C. When the temperature reached 50° C., 0.5 parts of 2,2′-azobis [2-(2-imidazolin-2-yl) propane] dihydrochloride (Wako Pure Chemical Industries, Ltd., product name: VA-044) was added to initiate a polymerization reaction. The mixture was stirred for 4 hours while the temperature was maintained at 50° C., and then 0.2 parts of VA-044 was further added. The resulting mixture was further stirred for 12 hours while the temperature was maintained at 50° C., affording an aqueous solution of copolymer 1. The copolymer 1 obtained had a viscosity-average molecular weight of 100,000.

### Preparation of Resin Composition 1

The aqueous solution of the copolymer 1 obtained as described above and N-methylpyrrolidone (also referred to as “NMP”) as a solvent were mixed at a mass ratio of 1:0.15, affording resin composition 1. The mass ratio of the copolymer 1, the organic solvent, and the water in the resin composition 1 was copolymer 1:organic solvent: water=8.7:13.0:78.3.

### Example 2

### Synthesis of Copolymer 2: GLBT-HPMA

A solution of copolymer 2 was obtained in the same manner as in Example 1 except that HPMA was used instead of HEMA. The copolymer 2 obtained had a viscosity-average molecular weight of 101,000.

### Preparation of Resin Composition 2

The solution of the copolymer 2 obtained as described above and NMP were mixed at a mass ratio of 1:0.15, affording resin composition 2. The mass ratio of the copolymer 2, the organic solvent, and the water in the resin composition 2 was copolymer 2: organic solvent: water=8.7:13.0:78.3.

### Example 3

### Synthesis of Copolymer 3: GLBT-HPMA-MAA (47/50/3))

A solution of copolymer 3 was obtained in the same manner as in Example 1 except that GLBT, HPMA, and MAA were dissolved in water such that the molar ratio was 47:50:3 and the total monomer concentration was 10%. The copolymer 3 obtained had a viscosity-average molecular weight of 100,000.

### Preparation of Resin Composition 3

The solution of the copolymer 3 obtained as described above and NMP were mixed at a mass ratio of 1:0.15, affording resin composition 3. The mass ratio of the copolymer 3, the organic solvent, and the water in the resin composition 3 was copolymer 3:organic solvent:water=8.7:13.0:78.3.

### Example 4

### Synthesis of Copolymer 4: GLBT-HPMA-MAA (45/50/5)

A solution of copolymer 4 was obtained in the same manner as in Example 3 except that the number of moles of GLBT was 45 mol, and the number of moles of MAA was 5 mol. The copolymer 4 obtained had a viscosity-average molecular weight of 98,000.

### Preparation of Resin Composition 4

The solution of the copolymer 4 obtained as described above and NMP were mixed at a mass ratio of 1:0.15, affording resin composition 4. The mass ratio of the copolymer 4, the organic solvent, and the water in the resin composition 4 was copolymer 4:organic solvent:water=8.7:13.0:78.3.

### Example 5

### Synthesis of Copolymer 5: GLBT-HPMA-MAA (43/50/7)

A solution of copolymer 5 was obtained in the same manner as in Example 3 except that the number of moles of GLBT was 43 mol, and the number of moles of MAA was 7 mol. The copolymer 5 obtained had a viscosity-average molecular weight of 100,000.

### Preparation of Resin Composition 5

The solution of the copolymer 5 obtained as described above and NMP were mixed at a mass ratio of 1:0.15, affording resin composition 5. The mass ratio of the copolymer 5, the organic solvent, and the water in the resin composition 5 was copolymer 5:organic solvent:water=8.7:13.0:78.3.

### Example 6

### Synthesis of Copolymer 6: GLBT-HPMA-MAA (40/50/10)

A solution of copolymer 6 was obtained in the same manner as in Example 3 except that the number of moles of GLBT was 40 mol, and the number of moles of MAA was 10 mol. The copolymer 6 obtained had a viscosity-average molecular weight of 95,000.

### (Preparation of Resin Composition 6

The solution of the copolymer 6 obtained as described above and NMP were mixed at a mass ratio of 1:0.15, affording resin composition 6. The mass ratio of the copolymer 6, the organic solvent, and the water in the resin composition 6 was copolymer 6:organic solvent:water=8.7:13.0:78.3.

### Example 7

### Synthesis of Copolymer 7: MAMCMB-HPMA-MAA (45/50/5)

A solution of copolymer 7 was obtained in the same manner as in Example 1 except that MAMCMB, HPMA, and MAA were dissolved in water:ethanol=80:20 such that the molar ratio was 45:50:5 and the total monomer concentration was 10%. The copolymer 7 obtained had a viscosity-average molecular weight of 76,000.

### Preparation of Resin Composition 7

The solution of the copolymer 7 obtained as described above and NMP were mixed at a mass ratio of 1:0.15, affording resin composition 7. The mass ratio of the copolymer 7, the organic solvent, the water, and the ethanol in the resin composition 7 was copolymer 7:organic solvent:water:ethanol=8.7:13.0:62.6:15.7.

### Example 8

### Synthesis of Copolymer 8: MAMCMB-HPMA-MAA (43/50/7)

A solution of copolymer 8 was obtained in the same manner as in Example 7 except that the number of moles of MAMCMB was 43 mol, and the number of moles of MAA was 7 mol. The copolymer 8 obtained had a viscosity-average molecular weight of 67,000.

### Preparation of Resin Composition 8

The solution of the copolymer 8 obtained as described above and NMP were mixed at a mass ratio of 1:0.15, affording resin composition 8. The mass ratio of the copolymer 8, the organic solvent, the water, and the ethanol in the resin composition 8 was copolymer 8:organic solvent:water:ethanol=8.7:13.0:62.6:15.7.

### Example 9

### Synthesis of Copolymer 9: MAMCMB-HPMA-MAA (40/50/10)

A solution of copolymer 9 was obtained in the same manner as in Example 7 except that the number of moles of MAMCMB was 40 mol, and the number of moles of MAA was 10 mol. The copolymer 9 obtained had a viscosity-average molecular weight of 67,000.

### Preparation of Resin Composition 9

The solution of the copolymer 9 obtained as described above and NMP were mixed at a mass ratio of 1:0.15, affording resin composition 9. The mass ratio of the copolymer 9, the organic solvent, the water, and the ethanol in the resin composition 9 was copolymer 9:organic solvent:water:ethanol=8.7:13.0:62.6:15.7. [Comparative Example 1]

### Synthesis of Copolymer a: MAMCMB-HPMA

A solution of copolymer a was obtained in the same manner as in Example 1 except that MAMCMB and HPMA were dissolved in water:ethanol=80:20 such that the molar ratio was 50:50 and the total monomer concentration was 10%. The copolymer a obtained had a viscosity-average molecular weight of 55,000.

### Preparation of Resin Composition a

The solution of the copolymer a obtained as described above and NMP were mixed at a mass ratio of 1:0.15, affording resin composition a. The mass ratio of the copolymer a, the organic solvent, the water, and the ethanol in the resin composition a was copolymer a:organic solvent:water:ethanol=8.7:13.0:62.6:15.7.

### Comparative Example 2

The mass ratio of the copolymer 7, the organic solvent, the water, and the ethanol in the resin composition 7 was copolymer 7:organic solvent:water:ethanol=8.7:13. 0:62.6:15.7.

### Synthesis of Copolymer b: MAMCMB-HEMA

A solution of copolymer b was obtained in the same manner as in Example 1 except that MAMCMB and HEMA were dissolved in water:ethanol=80:20 such that the molar ratio was 50:50 and the total monomer concentration was 10%. The copolymer b obtained had a viscosity-average molecular weight of 79,000.

### Preparation of Resin Composition b

The solution of the copolymer b obtained as described above and NMP were mixed at a mass ratio of 1:0.15, affording resin composition b. The mass ratio of the copolymer b, the organic solvent, the water, and the ethanol in the resin composition b was copolymer b:organic solvent:water:ethanol =8.7:13.0:62.6:15.7.

### Evaluation of Copolymer

### Solubility in Water

A copolymer liquid was spread on a Teflon (registered trademark)-coated tray, and then dried for 12 hours or more in a commercially available vacuum dryer set to 70° C. and 0.1 KPa or less, affording a solid of the copolymer. To 10 parts of the copolymer solid obtained was added 90 parts of water, and the mixture was stirred at room temperature for 30 minutes and then allowed to stand for 24 hours, and the state of the solution was evaluated according to the following criteria.
□: The solution is clear.
x: There remains some solid undissolved in the solution or the solution is cloudy.

### Degradability

A copolymer liquid was spread on a tray made of SUS, and then dried at 120° C. for 3 hours using a commercially available hot air dryer. The solid remaining on the tray made of SUS was collected, and the presence or absence of generation (presence or absence of a peak) of betaine alcohol (decomposition product) was confirmed using liquid chromatography.
□: The decomposition (hydrolysis) of the copolymer was confirmed.
x: No decomposition (hydrolysis) of the copolymer was confirmed.
It is noted that the hydrolysis rates were 16 mol % in Example 2 and 0 mol % in Comparative Examples 1 and 2. When no hydrolysis is confirmed, the hydrolysis rate is 0%.

### Formability of Insoluble Film

### (Low-Temperature Formability 1) Evaluation with Copolymer (Without Addition of Organic Solvent (NMP))

A copolymer liquid was spread on a Teflon (registered trademark)-coated tray, and then dried at 85° C. for 3 hours using a commercially available hot air dryer. To 10 parts of the copolymer solid obtained was added 90 parts of water, and the mixture was stirred at room temperature for 30 minutes and then allowed to stand for 24 hours, and the state of the solution was evaluated according to the following criteria.
□: The solution is clear.
x: There remains some solid undissolved in the solution or the solution is cloudy.

### Low-Temperature Formability 2) Evaluation with Resin composition (with addition of NMP)

90 parts of water was added to 10 parts of a copolymer solid obtained in the same manner as in the evaluation method of (Low-temperature formability 1) described above except that a resin composition was used instead of the copolymer. The resulting mixture was stirred at room temperature for 30 minutes and then allowed to stand for 24 hours, and the state of the resulting solution was evaluated according to the following criteria.
□: The solution is clear.
x: There remains some solid undissolved in the solution or the solution is cloudy.

### (High-Temperature Formability) Evaluation with Resin Composition (With Addition of NMP)

90 parts of water was added to 10 parts of a copolymer solid obtained in the same manner as in the evaluation method of (Low-temperature formability 1) described above except that a resin composition was used instead of the copolymer and drying was performed for 3 hours at 120° C. instead of 85° C. The resulting mixture was stirred at room temperature for 30 minutes and then allowed to stand for 24 hours, and the state of the resulting solution was evaluated according to the following criteria.
□: The solution is clear.
x: There remains some solid undissolved in the solution or the solution is cloudy.

### Evaluation of Water-Swellable Film

### Water Resistance 1: Visual Evaluation

2.5 parts of a resin composition was spread on a Teflon (registered trademark)-coated tray (10 cm×10 cm), and then left to stand in an atmosphere of 125° C. for 3 hours, affording a cured product. The cured product was peeled off from the tray, 2 parts of the peeled cured product was placed in a container, 98 parts of water was added, and the container was allowed to stand at room temperature for 24 hours. Thereafter, the state of the solution was visually checked and evaluated according to the following criteria. The evaluation results in parentheses indicate predicted values. The same applies to other evaluations described later.

### Evaluation Criteria

□: The cured product remains in a swollen state.
x: The cured product is dissolved or remains in a non-swollen state.

### (Water Resistance 2: Analytic Evaluation

The weight (w1) of an empty aluminum cup was measured, and 2.5 g of a resin composition was spread on the aluminum cup and then left to stand for 3 hours in an atmosphere of 125° C., affording a cured product. After measuring the weight (w2) of the aluminum cup on which the cured product is formed, 40 g of water is added, the aluminum cup is allowed to stand at room temperature for 1 hour, and then the weight (w3) of the aluminum cup from which only the supernatant has been removed is measured. After drying under reduced pressure for 3 hours in an atmosphere at 100° C., the weight (w4) is measured, and the elution rate is calculated from the following formula. A lower elution rate indicates higher water resistance.

$$( Calculation formula ) \\ Cured product dry weight = w 2 - w 1 \\ Dry weight after immersion = w 4 - w 1 \\ Elution rate ( \% ) = ( 1 - ( cured product dry weight - dry weight after \\ immersion ) / cured product dry weight ) \times 100$$

### Water Swellability 1: Visual Evaluation

2 parts of a cured product obtained in the same manner as described above for Water resistance 1 was placed in a container, 98 parts of water was added, and the container was allowed to stand at room temperature for 24 hours. Thereafter, the state of the resulting solution was visually checked and evaluated according to the following criteria.

### Evaluation Criteria

□: The cured product remains in a swollen state.
x: The cured product is dissolved or remains in a non-swollen state.

### Water Swellability (Gel Formability) 2: Analytic Evaluation

The weight (w1) of an empty aluminum cup was measured, and 2.5 g of a resin composition was spread on the aluminum cup and then left to stand for 3 hours in an atmosphere of 125° C., affording a water-swellable film. After measuring the weight (w2) of the aluminum cup on which the water-swellable film is formed, 40 g of water is added, the aluminum cup is allowed to stand at room temperature for 1 hour, and then the weight (w3) of the aluminum cup from which only the supernatant has been removed is measured. After drying under reduced pressure for 3 hours in an atmosphere at 100° C., the weight (w4) is measured, and the weight swelling rate is calculated from the following formula. A larger weight swelling rate indicates that the water-swellable film can contain a larger mass of water and also indicates that the water-swellable film is easily swollen and has high gel formability.

$$( Calculation formula )$$

$$Weight when swollen = w 3 - w 1$$

$$Dry weight after immersion = w 4 - w 1$$

$$Weight swelling rate ( times ) = weight when swollen / dry weight \\ after immersion$$

### Slip Durability (Gel Adhesion)

The samples used for the evaluation of film strength were prepared by providing, as a substrate, a wire having a metal coil section or a wire having a urethane coating layer on the surface of a metal coil section, and covering a portion of the substrate including the metal coil section with each of the resin compositions by a dip coating method. After each of the resin compositions was applied to a wire, the resin composition was dried for 1 hour using a hot air circulating drying furnace at 120° C. to obtain, affording an evaluation sample. The evaluation sample obtained was sandwiched between a urethane roller (AXFM-D25-L15-V8-N, manufactured by MISUMI Corporation) and a stainless steel sheet (SUS304 sheet, 30×30 mm) in an underwater environment, and a resistance value when one end connected to a load cell was pulled out with application of a load of 0.981 N was measured. The same measurement was continuously performed 50 times, and the initial resistance value at the first time was compared with the resistance value at the 50th time to evaluate the film strength (adhesion of the film). A smaller resistance value can be evaluated to indicate higher film strength and higher durability during sliding.

### Lubricity

For the evaluation of lubricity, the same samples as the samples used for the evaluation of film strength were used. Each of the samples was immersed in physiological saline, and thereafter, the feeling when the coated portion was nipped and rubbed with fingertips was compared according to the following criteria. The evaluation results are shown in Table 3 below.

### Evaluation Criteria

□: The surface slips so good that the sample cannot be held by hand
x: The cured product flows out and the sample exhibited poor slippage

The monomer compositions of the copolymers obtained in Examples and Comparative Examples are shown in Table 2, and the results of the evaluations of insoluble film formability and so on are shown in Table 3.

TABLE 2

| | | | Structural unit [mol %] | | | | | | |
|---|---|---|---|---|---|---|---|---|---|
| | | | | | Carboxyl group- | | | Viscosity- | |
| | | | Betaine | | containing | Hydrophilic | | average | |
| | | | monomer | | monomer | monomer | | molecular | |
| | | | (i) | (ii) | (iii) | (vi) | | weight | |
| | | Copolymer | GLBT | MAMCMB | MAA | HPMA | HEMA | [×10,000] | K |
| Example | 1 | 1 | 50 | — | — | — | 50 | 100,000 | 47 |
| | 2 | 2 | 50 | — | — | 50 | — | 101,000 | 47 |
| | 3 | 3 | 47 | — | 3 | 50 | — | 100,000 | 48 |
| | 4 | 4 | 45 | — | 5 | 50 | — | 98,000 | 47 |
| | 5 | 5 | 43 | — | 7 | 50 | — | 100,000 | 48 |
| | 6 | 6 | 40 | — | 10 | 50 | — | 95,000 | 46 |
| | 7 | 7 | — | 45 | 5 | 50 | — | 76,000 | 41 |
| | 8 | 8 | — | 43 | 7 | 50 | — | 67,000 | 39 |
| | 9 | 9 | — | 40 | 10 | 50 | — | 75,000 | 41 |
| Comparative | 1 | a | — | 50 | — | 50 | — | 55,000 | 35 |
| Example | 2 | b | — | 50 | — | — | 50 | 79,000 | 42 |

TABLE 3

| | | | | | Insoluble film formability | | |
|---|---|---|---|---|---|---|---|
| | | | | | Copolymer | Resin | |
| | | | Copolymer | | (without | composition | |
| | | | Solubility | | NMP) | (with NMP) | |
| | | Copolymer | in water | Degradability | 85° C. | 85° C. | 120° C. |
| Example | 1 | 1 | ◯ | ◯ | X | X | ◯ |
| | 2 | 2 | ◯ | ◯ | X | X | ◯ |
| | 3 | 3 | ◯ | ◯ | X | X | ◯ |
| | 4 | 4 | ◯ | ◯ | X | X | ◯ |
| | 5 | 5 | ◯ | ◯ | X | ◯ | ◯ |
| | 6 | 6 | ◯ | ◯ | X | ◯ | ◯ |
| | 7 | 7 | ◯ | X | X | ◯ | ◯ |
| | 8 | 8 | ◯ | X | X | ◯ | ◯ |
| | 9 | 9 | ◯ | X | X | ◯ | ◯ |
| Comparative | 1 | a | ◯ | X | X | X | X |
| Example | 2 | b | ◯ | X | X | X | X |

| | | Water-swellable film | | | | | |
|---|---|---|---|---|---|---|---|
| | | Water swellability | | Water resistance | | | |
| | | | 2 | | 2 | Slip | |
| | | 1 | [times] | 1 | [%] | durability | Lubricity |
| Example | 1 | ◯ | — | ◯ | — | ◯ | ◯ |
| | 2 | ◯ | 4.6 | ◯ | 29.9 | ◯ | ◯ |
| | 3 | ◯ | — | (◯) | — | (◯) | (◯) |
| | 4 | ◯ | — | (◯) | — | (◯) | (◯) |
| | 5 | ◯ | — | (◯) | — | (◯) | (◯) |
| | 6 | ◯ | — | ◯ | — | ◯ | ◯ |
| | 7 | ◯ | 17.5 | ◯ | 60.9 | Δ | Δ |
| | 8 | ◯ | 13.6 | ◯ | 37.9 | ◯ | ◯ |
| | 9 | ◯ | 10.1 | ◯ | 35.5 | ◯ | Δ |
| Comparative | 1 | X | — | X | 99.7 | X | X |
| Example | 2 | X | — | X | 98.9 | X | X |

### Resin Compositions 5-1 to 5-21

Resin compositions 5-2 to 5-16 were obtained in the same manner as in Example 5 except that the solvents given in Table 4 were used instead of NMP in the resin composition 5 (in Table 4, indicated as resin composition 5-1) containing the copolymer 5 obtained in Example 5. The insoluble film formability, water resistance, and water swellability of these resin compositions were measured in the same manner as described above. The results are shown in Table 4. Resin compositions 5-1, 5-5, and 5-7 to 5-10 in Table 4 are resin compositions according to the present invention.

TABLE 4

| | Organic solvent | | | | | Evaluation results of resin composition | | |
|---|---|---|---|---|---|---|---|---|
| | | Hansen solubility | | | Boiling | Insoluble film | Water | Water |
| Resin | | parameter | | | point | formability | resistance | swellability |
| composition | Type | δD | δP | δH | [° C.] | (85° C.) | 1 | 1 |
| 5-1 | NMP | 18.0 | 12.3 | 7.2 | 202.0 | ◯ | ◯ | ◯ |
| 5-2 | Acetone | 15.5 | 10.4 | 7.0 | 56.5 | X | X | X |
| 5-3 | Acetonitrile | 15.3 | 18.0 | 6.1 | 82.0 | X | X | X |
| 5-4 | n-Butyl acetate | 15.8 | 3.7 | 6.3 | 126.0 | X | X | X |
| 5-5 | Diacetone alcohol | 15.8 | 8.2 | 10.8 | 166.0 | ◯ | ◯ | ◯ |
| 5-6 | Diethylene glycol | 16.6 | 12.0 | 19.0 | 245.0 | X | X | X |
| 5-7 | Diethylene glycol | 16.1 | 9.2 | 12.2 | 196.0 | ◯ | ◯ | ◯ |
| | monoethyl ether | | | | | | | |
| 5-8 | Dimethylacetamide | 16.8 | 11.5 | 9.4 | 165.0 | ◯ | ◯ | ◯ |
| 5-9 | Dimethylformamide | 17.4 | 13.7 | 11.3 | 153.0 | ◯ | ◯ | ◯ |
| 5-10 | Dimethyl sulfoxide | 18.4 | 16.4 | 10.2 | 189.0 | ◯ | ◯ | ◯ |
| 5-11 | Ethanol | 15.8 | 8.8 | 19.4 | 78.3 | X | X | X |
| 5-12 | Ethylene glycol | 17.0 | 11.0 | 26.0 | 197.0 | X | X | X |
| 5-13 | Methanol | 14.7 | 12.3 | 22.3 | 64.7 | X | X | X |
| 5-14 | Tetrahydrofuran | 16.8 | 5.7 | 8.0 | 66.0 | X | X | X |
| 5-15 | Toluene | 18.0 | 1.4 | 2.0 | 110.6 | X | X | X |
| 5-16 | Water | 15.5 | 16.0 | 42.3 | 100.0 | X | X | X |

1. A resin composition comprising:
a polymer (I) selected from the group consisting of a polymer (a1) containing a structural unit (i) having an ester linkage type betaine structure and a polymer (b1) containing a structural unit (ii) having a betaine structure that is not of an ester linkage type and a structural unit (iii) having a carboxyl group;
an organic solvent having a Hansen solubility parameter at 25° C. in which a dispersion term δD is 10 to 24 MPa^{1/2}, a polarity term δP is 5 to 19 MPa^{1/2}, and a hydrogen bonding term δH is 3 to 17 MPa^{1/2}, and having a boiling point higher than 100° C.; and
water.

2. The resin composition according to claim 1, wherein
the ester linkage type betaine structure and/or the betaine structure that is not of an ester linkage type is represented by formula (1): 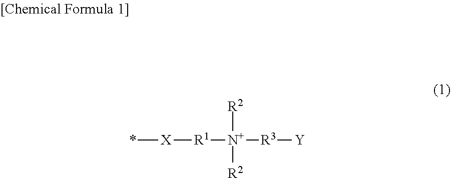
wherein:
R¹ represents a linear or branched alkylene group having 1 to 6 carbon atoms,
R² independently at each occurrence represents a linear or branched alkyl group having 1 to 4 carbon atoms,
R³ represents a linear or branched alkylene group having 1 to 4 carbon atoms,
X represents —C(═O)—O— in an ester linkage type betaine structure, and —C(═O)—N(—H)— in a betaine structure that is not of an ester linkage type,
Y represents —SO₃⁻ or —COO⁻, and
* represents a bond.

3. The resin composition according to claim 1, wherein the polymer (a1) or the polymer (b1) further contains a structural unit having at least one hydrophilic structure.

4. The resin composition according to claim 1, wherein the structural units (i) to (iii) are each a structural unit derived from a (meth)acrylic monomer or a vinyl monomer.

5. The resin composition according to any one of claim 1, comprisng the polymer (I) in an amount of 5% by mass to 30% by mass based on a total amount of the resin composition.

6. The resin composition according to claim 1, which is a coating agent.

7. A water-swellable film comprising a polymer (II) selected from the group consisting of a polymer (a2) containing a structural unit (iv) having an ester linkage type betaine structure and a structural unit (v) having a carboxyl group, and a polymer (b1) containing a structural unit (ii) having a betaine structure that is not of an ester linkage type and a structural unit (iii) having a carboxyl group.

8. An article covered with the water-swellable film according to claim 7, provided that elongated medical devices and components thereof are excluded.

9. A method for producing the water-swellable film according to claim 7, the method comprising:
an application step of applying the resin composition according to claim 1 to a substrate; and
a film formation step of heating a coating film of the applied resin composition to form a water-swellable film.

10. The method according to claim 9, wherein the film formation step is a step of heating the coating film of the applied resin composition at a temperature higher than 90° C., and in the film formation step, the polymer (a1) containing the structural unit (i) having an ester linkage type betaine structure is hydrolyzed to form a polymer (a2) containing a structural unit (iv) having an ester linkage type betaine structure and a structural unit (v) having a carboxyl group.

11. The method according to claim 10, wherein a hydrolysis rate from the polymer (a1) to the polymer (a2) is 5 mol % or more and 60 mol % or less.
